(19) United States
(12) Patent Application Publication
(10) Pub. No.: US 2017/0024837 A1
(43) Pub. Date: Jan. 26, 2017

(54) METHOD AND APPARATUS FOR IMPROVING A PUBLIC TRANSPORT SYSTEM

(71) Applicant: MasterCard International Incorporated, Purchase, NY (US)

(72) Inventor: Anshul Pandey, Gurgaon (IN)

(21) Appl. No.: 15/212,448

(22) Filed: Jul. 18, 2016

(30) Foreign Application Priority Data
Jul. 24, 2015 (SG) 10201505797X

(51) Int. Cl. G06Q 50/26; G08G 1/123; G06Q 10/06; G01C 21/34

(52) U.S. Cl. CPC G06Q 50/26; G01C 21/3453; G08G 1/123; G06Q 10/06312

(57) ABSTRACT

Method and apparatus for improving a public transport system is disclosed. The method comprises obtaining transaction data representing past transactions performed by a plurality of consumers via a payment network. The transaction data is indicative of geographic locations at which the respective transactions were carried out. For each of the consumers, at least one journey segment performed by the consumer is identified using a first geographic location associated with a first past transaction and a second geographic location. The method further comprises storing in a database the identified journey segments and corresponding counts associated with the respective journey segments; determining a capacity index representing a capability of an existing public transport system to accommodate at least one of the identified journey segments using the database; and generating a notification to modify a transport operation undertaken by a public transport operator based on the capacity index. A method of performing a transport operation is also provided.

### CROSS-REFERENCE TO RELATED APPLICATION

This application is a U.S. National Stage filing under 35 U.S.C. §119, based on and claiming benefit of and priority to SG Patent Application No. 10201505797X filed Jul. 24, 2015.

### FIELD AND BACKGROUND

A method and apparatus for improving a public transport system is disclosed. In particular, a method and apparatus for modelling traffic data for modifying a transport operation undertaken by a public transport operator is disclosed.

Travelling is part and parcel of modern urban living—people travel for work, education, recreation and many other reasons. Public transport (e.g. buses, trains and taxis etc.) is the most often used by people to travel from one place to another and is considered an essential service in most urban areas. Therefore, it has been one of the top priorities for society to improve the efficiency and effectiveness of the public transport system to enhance commuters' travel experience. This includes increasing an availability of public transport services for under-supplied routes, for example, by establishing new connections, improving schedules of public buses or train services, as well as optimizing efficiency of taxi systems. Currently, this is being done by doing research or studying population density and census data etc, for example, in order to understand how frequencies of buses should be altered during peak hours of a day.

However, such studies and researches require extensive efforts and resources in data collection, manipulation and interpretation, which are tedious and may not be accurate. Therefore, it would be desirable to have a more effective method and apparatus for improving the public transport system.

### SUMMARY

The present disclosure provides a more effective and quantitative way of modelling traffic data to modify a transport operation undertaken by a public transport operator, thereby improving the system. Typically, a notification indicative of a journey segment in demand may be generated. This may allow public transport operators to obtain information on traffic patterns and behaviours of commuters and, in response, to modify a transport operation of a public vehicle to accommodate such demand.

In general terms, the present method proposes using geographic data from transaction level data to model traffic patterns of the population. The transaction level data describes past transactions carried out by consumers over a payment network.

According to a first expression, there is provided a computer-implemented method for improving a public transport system. The method comprises:

(a) obtaining, by a transaction analysis component, transaction data representing past transactions performed by a plurality of consumers via a payment network, said transaction data comprising geographic data indicative of geographic locations at which the respective transactions were carried out;

(b) for each of the consumers, identifying, by a location analysis component, at least one journey segment performed by the consumer using a first geographic location associated with a first one of said past transactions, and a second geographic location;

(c) the location analysis component storing, in a database, the identified journey segments and corresponding counts associated with the respective journey segments;

(d) determining, by an operation optimization component, a capacity index representing a capability of an existing public transport system to accommodate at least one of the identified journey segments using the database; and

(e) generating, by the operation optimization component, a notification to modify a transport operation undertaken by a public transport operator based on the capacity index.

Advantageously, the geographic locations of the transactions can be obtained easily from the transaction level data, which is then utilized to track movements of consumers. For example, a change in the geographic locations may be monitored, from which the demand for a trip or journey segment of the consumers may be deduced. In other words, modelling may be performed to study and infer the traffic patterns of the consumers and/or the general population. This allows a capability of the existing public transport system to accommodate such traffic patterns to be determined or estimated. Consequently, public transport operators may recognize a need to enhance their capacity for accommodating certain journey segments by, for example, modifying their current or scheduled route.

The geographic data can be conveniently obtained based on, for example, the merchants' geographic locations at which the transactions were carried out. That is, point of sale (POS) locations or ATM locations.

In some embodiments, the transaction data is further indicative of a transaction time associated with each of the respective transactions. This enables traffic patterns to be characterized further with respect to different time periods. In other words, variations in the traffic patterns across a day, a week, a month or even a year may be tracked and accounted for to optimize public transport availability at any selected time frame.

In some embodiments, the second geographic location is a base location of the consumer. The base location may be a home location or an office location of the consumer. In one example, the base location may be obtained from a payment system at which the consumer has previously registered. In another example, the base location may be obtained from a financial institution administering a payment account of the consumer with which the transaction was carried out.

In some embodiments, the second geographic location is a geographic location associated with a second past transaction. The second past transaction may be performed within a pre-defined time window from the first past transaction. As such, the journey segment identified is likely to be a more accurate estimation of the actual journey segment in demand by the consumer.

In some other embodiments, operation (b) may comprise identifying a plurality of journey segments for each of the consumers. The plurality of journey segments comprise journey segments defined by geographic locations associated with chronologically sequential transactions performed by the consumer within a pre-defined time window. The sequential transactions may be, but are not necessarily, consecutive. Thus, multiple journey segments associated with chronologically sequential transactions can be closely monitored to provide a more comprehensive understanding of consumer's traffic pattern and behaviours.

In some embodiments, the corresponding counts comprise respective counts associated with the respective journey segments performed by a plurality of the consumers. In other words, this allows a traffic pattern of each consumer to be obtained and analysed, which is potentially useful for providing customized public transport service, such as taxi services, for each individual consumer.

In some embodiments, at least one candidate journey segment is selected using the corresponding frequencies associated with the respective journey segments and the capacity index is determined in respect of the at least one candidate journey segment. A target journey segment is identified from the at least one candidate journey segment using its capacity index. The method may further comprise generating a notification informing a public transport service provider of the target journey segment. The public transport service provider may be a taxi service provider or a bus service provider.

In some embodiments, the corresponding counts associated with the respective journey segments may be the corresponding frequencies (i.e. the counts within a certain time window).

In some embodiments, the method may comprise distributing the notification to modify the transport operation being undertaken by the public transport operator in response to the notification in real time. This works towards an immediate optimization of the public transport system in real time.

In some embodiments, the method may comprise delivering the notification to cause the transport operation undertaken by the public transport operator to be modified in a scheduled future time. For example, time-series modelling (which typically uses past patterns in data to predict the future) of traffic patterns may be conducted to identify possible new routes or improved schedules, or even new connections between two locations. Predictive modelling may be performed to obtain a statistical model of future behaviour of one or more consumers, for example, a model which forecast the likelihood of a certain route (that is associated with one or more future destinations) to be undertaken by the consumers at a future time point or a time range. In particular, the route associated with the highest likelihood at a future time can be obtained, which may be used for modifying the transport operation at that time accordingly.

In some embodiments, operation (e) comprises modifying at least one selected from (i) a route serviced by the public transport operator, and (ii) a schedule undertaken by the public transport operator.

According to a second expression, there is provided an apparatus for improving a public transport system. The apparatus has a computer processor and a data storage device, the data storage device having a transaction analysis component, a location analysis component and an operation optimization component comprising non-transitory instructions operative by the processor to:

obtain transaction data representing past transactions performed by a plurality of consumers via a payment network, said transaction data comprising geographic data indicative of geographic locations at which the respective transactions were carried out;

for each of the consumers, identify at least one journey segment performed by the consumer using a first geographic location associated with a first one of said past transactions, and a second geographic location;

store, in a database, the identified journey segments and corresponding counts associated with the respective journey segments;

determine a capacity index representing a capability of an existing public transport system to accommodate at least one of the identified journey segments using the database; and

generate a notification to modify a transport operation undertaken by a public transport operator based on the capacity index.

According to another expression, there is provided a non-transitory computer-readable medium, the computer-readable medium having stored thereon program instructions for causing at least one processor to perform a method as disclosed above.

According to a further expression, there is provided a method of performing a transport operation. The method comprises operating a vehicle along a journey segment using a notification generated according to a method as disclosed above.

The term “public transport system” encompasses vehicles and operations offering a transport service which is available for use by the general public (with or without private arrangement), as distinct from vehicles owned by private entities for exclusive and private use. The term public transport system thus includes but is not limited to, buses, trains, subway, rapid transit, taxis, auto-rickshaws, carpooling or hired/chartered buses.

### BRIEF DESCRIPTION OF THE DRAWINGS

Embodiments of the invention will now be described for the sake of non-limiting example only, with reference to the following drawings in which:

FIG. 1 is a block diagram illustrating a system according to an embodiment, and

FIG. 2 is a flow diagram of a method according to an embodiment.

### DETAILED DESCRIPTION

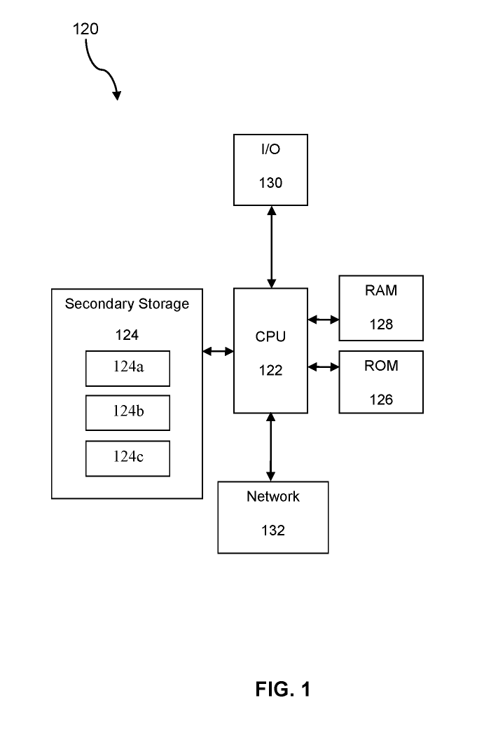

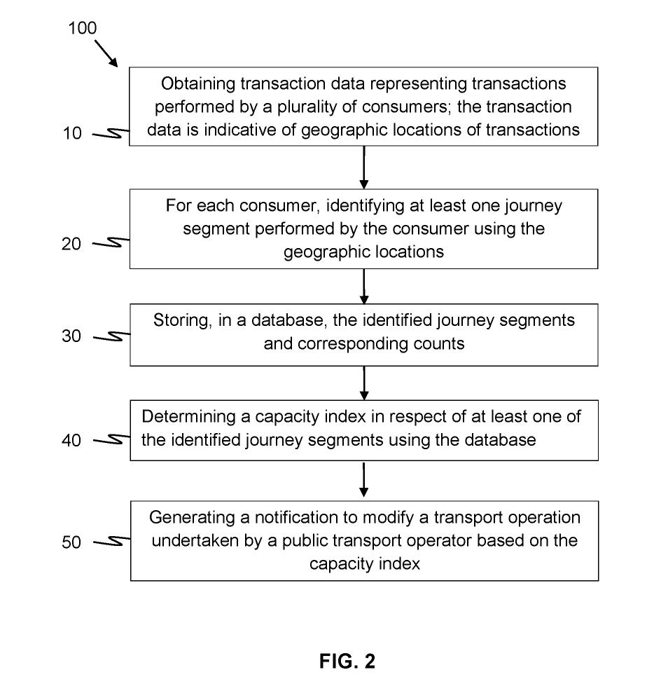

FIG. 2 shows an exemplary method 100 for improving a public transport system using transactional level data. The method 100 may be implemented by a computer having a data-processing unit. The block diagram as shown in FIG. 1 illustrates a technical architecture 120 of a computer which is suitable for implementing one or more embodiments herein.

The technical architecture 120 includes a processor 122 (which may be referred to as a central processor unit or CPU) that is in communication with memory devices including secondary storage 124 (such as disk drives), read only memory (ROM) 126, random access memory (RAM) 128. The processor 122 may be implemented as one or more CPU chips. The technical architecture 120 may further comprise input/output (I/O) devices 130, and network connectivity devices 132.

The secondary storage 124 is typically comprised of one or more disk drives or tape drives and is used for non-volatile storage of data and as an over-flow data storage device if RAM 128 is not large enough to hold all working data. Secondary storage 124 may be used to store programs which are loaded into RAM 128 when such programs are selected for execution. In this embodiment, the secondary storage 124 has a transaction analysis component 124a, a location analysis component 124b and an operation optimization component 124c comprising non-transitory instructions operative by the processor 122 to perform various operations of the method of the present disclosure. The ROM 126 is used to store instructions and perhaps data which are read during program execution. The secondary storage 124, the RAM 128, and/or the ROM 126 may be referred to in some contexts as computer readable storage media and/or non-transitory computer readable media.

I/O devices 130 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 132 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 132 may enable the processor 122 to communicate with the Internet or one or more intranets. With such a network connection, it is contemplated that the processor 122 might receive information from the network, or might output information to the network in the course of performing the above-described method operations. Such information, which is often represented as a sequence of instructions to be executed using processor 122, may be received from and outputted to the network, for example, in the form of a computer data signal embodied in a carrier wave.

The processor 122 executes instructions, codes, computer programs, scripts which it accesses from hard disk, floppy disk, optical disk (these various disk based systems may all be considered secondary storage 124), flash drive, ROM 126, RAM 128, or the network connectivity devices 132. While only one processor 122 is shown, multiple processors may be present. Thus, while instructions may be discussed as executed by a processor, the instructions may be executed simultaneously, serially, or otherwise executed by one or multiple processors.

Although the technical architecture 120 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 120 to provide the functionality of a number of servers that is not directly bound to the number of computers in the technical architecture 120. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 120, at least one of the CPU 122, the RAM 128, and the ROM 126 are changed, transforming the technical architecture 120 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Various operations of the exemplary method 100 will now be described with reference to FIGS. 1 and 2. It should be noted that enumeration of operations is for purposes of clarity and that the operations need not be performed in the order implied by the enumeration.

At step 10, the transaction analysis component 124a of the architecture 120 receives transaction data representing past transactions performed by a plurality of customers via a payment network.

Such transactions typically involve payments made via a cashless payment device such as a payment card. The payment card may be a credit card, a debit card, a prepaid card, a charge card, a membership card, a promotional card, a frequent flyer card, an identification card, a prepaid card, a gift card. The cashless payment device may also include other device that may hold payment account information, such as mobile phones, Smartphones, personal digital assistants (PDAs), key fobs, transponder devices, NFC-enabled devices, and/or computers.

The payment network may be any electronic payment network which connects, directly and/or indirectly payers (the customer and/or their banks or similar financial institutions) with payees (the merchants and/or their banks or similar financial institutions). Non-limiting examples of the payment network are a payment card type of network such as the payment processing network operated by MasterCard, Inc., mobile telephone payment networks and the like (it should be noted that the primary purpose of the payment network may not be payment; for example, a mobile telephony network may offer payment network capability even though its primary purpose may be mobile telephony).

The transaction data can be received directly from the payment network over a communication network, or from a database in communication with the system, e.g. a data warehouse which stores anonymized transaction data from the payment network. In some embodiments, the technical architecture 120 is arranged to be in communication with the payment network to receive real-time transaction data in respect of transactions carried out by the consumers. The technical architecture 120 may be configured to be in communication with the data warehouse storing past transaction data to receive the transaction data at pre-defined time intervals.

The transaction data comprises geographic information about a geographic location for each transaction. Such geographic information may be derived from a merchant's information which is typically included in the transaction data. For example, the merchant's identity data, full address and/or GPS data. In some embodiments, the geographic location specifies a full address, a building address, a street address or any other geographic segmentation defining a geographic proximity. The transaction data may further comprise data indicative of transaction time and date. Further information such as acquirer identifier/card accepter identifier (the combination of which uniquely defines a merchant); merchant category code (also known as card acceptor business code), that is, an indication of the type of business the merchant is involved in; cardholder base currency (i.e., U.S. Dollars, Euros, Yen, etc.); transaction time and date; transaction amount; (also referred to herein as ticket size); terminal identifier (e.g., merchant terminal identifier or ATM identifier) may also be available from the transaction data.

At step 20, the location analysis component 124b identifies, for each consumer, at least one journey segment performed by the consumer from the transaction data. For example, the journey segment may be identified based on the geographic locations of two chronologically consecutive transactions carried out by the consumer within a pre-defined period, such as within a day, half a day or 2 hours, etc. The assumption is that the consumer had travelled from a first geographic location associated with the first transaction to a second geographic location associated with the later transaction. In some embodiments, it is possible to arrive at a more specific estimation that the consumer had travelled directly from the first geographic location to the second without stopping at or detouring to an interim location, especially if the difference in the transaction time of the two transactions is relatively small.

It is also possible to identify the journey segment using a base location of the consumer and a geographic location of a past transaction. The base location could be a residential address or office address associated with the consumer. The past transaction may be a chronological first or last transaction during a pre-defined period, such as during a day, or half a day. The assumption is that the consumer would have made a trip between the base location and the geographic location to perform the transaction.

In one example, the base location of the consumer may be obtained from a payment system at which the consumer has previously registered, such as the MasterCard™'s “MasterPass™” system. In other examples, the method 100 may comprise obtaining the base location of the consumer from a financial institution administering a payment account, for example, the issuing banks, of the consumer with which the transaction was carried out.

In some embodiments, the location analysis component 124b may identify a plurality of journey segments for each of the consumers using geographic locations associated with each of a plurality of chronologically consecutive transactions. This allows the journey segments performed by the consumer to be closely monitored to analyse the traffic pattern of the individual consumers. In another embodiment, a general traffic pattern associated with the general population may be deduced by analysing frequencies of the various journey segments performed by all of the consumers.

At step 30, a database which stores the identified journey segments is formed by the location analysis component 124b. The database further stores the corresponding frequencies associated with the respective identified journey segments. The frequencies may be indicative of a number of trips performed by the consumers for the respective journey segments during a pre-defined period. For example, the number of trips made between any two geographic locations during a month, a week or even during a certain period of a day may be obtained. In one example, the frequency is determined for each individual consumer. In another example, the frequency is determined in respect of all consumers.

At step 40, a capacity index is determined in respect of at least one of the identified journey segments, for example, by an algorithm of the operation optimizing component 124c. The capacity index for a journey segment is indicative of a capability of an existing public transport system in accommodating that journey segment, for example, at a particular time point or within a pre-determined time window such as up to 10 minutes, 20 minutes, 30 minutes, 1 hour, 2 hours, 4 hours or even 8 hours. The index may be determined using existing data representing public transport availability such as schedules of buses and/or trains serving the journey or even the number of available taxis in that area (i.e. indicative of the supply). As described above, the traffic pattern associated with the journey segment performed by the consumers at any particular time point (i.e. indicative of the demand) can be obtained using the method of the present disclosure. In one example, at least one candidate journey segment is selected based on the corresponding frequency and an associated capacity index is determined for that candidate journey segment. In another example, the at least one candidate journey segment is selected based on the corresponding count.

At step 50, the operation optimization component 124c generates a notification based on the capacity index to modify a transport operation undertaken by a public transport operator. For example, a target journey segment can be identified using the capacity index of the at least one candidate journey segment and the notification is generated informing the public transport operator of the target journey segment. The notification may be used to modify the operation being undertaken by the public transport operator in real time or a scheduled future time. The notification may comprise a journey segment or at least one geographic location associated with the journey segment.

For example, the journey segments which have corresponding counts and/or frequencies higher than a pre-determined threshold value are selected as the candidate journey segments. In this example, these candidate journey segments thus represent trips frequently made by consumers. Based on this, the traffic patterns of the general population may be deduced, for example, by assuming that the number of journey segments performed by the consumers constitute a certain proportion of those performed by the general population and extrapolate the data accordingly. For each of the candidate journey segments, if it is estimated that the existing public transport system is not sufficient to handle the traffic pattern, a notification may be generated to inform a public transport service provider such as a taxi company of such unmet demand associated with the journey segment. As a response, taxi drivers may be informed to modify their current route to travel to the geographic locations associated the journey segments thereby meeting the demand in real time. It will be understood that the notifications may be transmitted directly to the individual taxi drivers. The public transport service provider may also include limousine or hired buses.

In some embodiments, the journey segments which define routes with limited accessibility to public transport (e.g. with few or no buses or trains serving the routes) are given a higher priority when selecting journey segments for the notification generation.

In other embodiments, a capacity index may be determined for each of the identified journey segments and the journey segments with one of the lowest capacity indices are selected for the generation of the notification.

In some embodiments, the traffic patterns of the general population may be obtained for route or schedule planning of the public transport system. In particular, time-series modelling may be used for estimating traffic patterns in a future time so that the public transport network can be configured accordingly to optimize its efficiency and availability. In one example, predictive modelling is performed to obtain a statistical model which forecasts the likelihood of each of various routes associated with one or more future destinations to be undertaken by one or more consumers. The route associated with the highest likelihood at a future time is obtained and a schedule of a transport operation is set to improve the availability at that time accordingly.

In some embodiments, the traffic patterns of the consumers may be monitored during a prolonged period of time, such as a year. This allows the traffic trends during occasions (such as festive occasions or major sporting events etc.) to be identified and be accounted for when optimizing the public transport network during similar occasions in a future time.

The method 100 may further comprise delivering or distributing the notification to modify the transport operation conducted by the public transport operator.

### Advantages and Industrial Applications

The method and apparatus of the present disclosure provides the following advantages and applications:

1. Establishing new public transport connections in the areas needed, for example, suggesting new locations to set up bus stops, train stations and taxi stands based on the popularity of the geographic locations, the associated journey segments and/or the current public transport service available in the vicinity;

2. Altering frequency of public transport services, for example, adjusting the schedule of bus or train services during a specific period of a day or during specific days of a week, etc. based on an estimation of future traffic patterns obtained from modelling historical or current traffic patterns;

3. Identifying and planning new routes for providing public transport, including altering routes of the existing bus or train services during a specific period of a day or during specific days of a week based on the estimated future traffic patterns; and

4. Optimizing the existing public transport network according to demand in real time, for example, by generating notifications to taxis informing them of currently under-supplied journey segments.

Whilst the foregoing description has described exemplary embodiments, it will be understood by those skilled in the art that many variations of the embodiment can be made within the scope and spirit of the present invention. For example, notifications may be generated to inform taxis of a prediction of increased demand at a geographic location at a scheduled future time.

1. A computer-implement method for improving a public transport system, comprising:
(a) obtaining, by a transaction analysis component, transaction data representing past transactions performed by a plurality of consumers via a payment network, said transaction data comprising geographic data indicative of geographic locations at which the respective transactions were carried out;
(b) for each of the consumers, identifying, by a location analysis component, at least one journey segment performed by the consumer using a first geographic location associated with a first one of the past transactions, and a second geographic location;
(c) the location analysis component storing, in a database, the identified journey segments and corresponding counts associated with the respective journey segments;
(d) determining, by an operation optimization component, a capacity index representing a capability of an existing public transport system to accommodate at least one of the identified journey segments using the database; and
(e) generating, by the operation optimization component, a notification to modify a transport operation undertaken by a public transport operator based on the capacity index.

2. A computer-implemented method according to claim 1, wherein the transaction data is indicative of a transaction time associated with each of the respective transactions.

3. A computer-implemented method according to claim 1, wherein the second geographic location is a base location of the consumer, the base location being a home location or an office location of the consumer.

4. A computer-implemented method according to claim 3 comprising obtaining the base location of the consumer from a payment system at which the consumer has previously registered.

5. A computer-implemented method according to claim 3 comprising obtaining the base location of the consumer from a financial institution administering a payment account of the consumer with which the transaction was carried out.

6. A computer-implemented method according to claim 2, wherein the second geographic location is a geographic location associated with a second past transaction; the second past transaction being performed within a pre-defined time window from the first past transaction.

7. A computer-implemented method according to any of claim 1, in which operation (b) comprises identifying a plurality of journey segments for each of the consumer, the plurality of journey segments comprising journey segments defined by geographic locations associated with chronologically consecutive transactions performed by the consumer within a pre-defined time window.

8. A computer-implemented method according to claim 1, in which the corresponding counts comprise respective counts associated with the respective journey segments performed by each of the consumers.

9. A computer-implemented method according to any preceding claim, in which operation (d) comprises selecting at least one candidate journey segment using the corresponding counts associated with the respective journey segments and determining the capacity index in respect of the at least one candidate journey segment.

10. A computer-implemented method according to claim 9, in which operation (e) comprises identifying a target journey segment using the capacity index of the at least one candidate journey segment, and generating a notification informing the public transport operator of the target journey segment.

11. A computer-implemented method according to claim 1, wherein the public transport operator is selected from one of (i) a taxi service provider and (ii) a bus service provider.

12. A computer-implemented method according to claim 1, comprising distributing the notification to modify the transport operation being undertaken by the public transport operator in response to the notification in real time.

13. A computer-implemented method according to claim 1, comprising delivering the notification to cause the transport operation undertaken by the public transport operator to be modified in a scheduled future time.

14. A computer-implemented method according to claim 1, wherein operation (e) comprises modifying at least one selected from (i) a route serviced by the public transport operator, and (ii) a schedule undertaken by the public transport operator.

15. A computer-implemented method according to claim 1, wherein the corresponding counts associated with the respective journey segments are the corresponding frequencies associated with the respective journey segments.

16. An apparatus for improving a public transport system, comprising:
a computer processor and a data storage device, the data storage device having a transaction analysis component, a location analysis component and an operation optimization component comprising non-transitory instructions operative by the processor to:
obtain transaction data representing past transactions performed by a plurality of consumers via a payment network, said transaction data comprising geographic data indicative of geographic locations at which the respective transactions were carried out;
for each of the consumers, identify at least one journey segment performed by the consumer using a first geographic location associated with a first one of the past transactions, and a second geographic location;
store, in a database, the identified journey segments and corresponding counts associated with the respective journey segments;
determine a capacity index representing a capability of an existing public transport system to accommodate at least one of the identified journey segments using the database; and
generate a notification to modify a transport operation undertaken by a public transport operator based on the capacity index.

17. An apparatus according to claim 16, wherein the transaction data is indicative of a transaction time associated with each of the respective transactions.

18. An apparatus according to claim 16, wherein the second geographic location is a base location of the consumer, the base location being a home location or an office location of the consumer.

19. An apparatus according to claim 18, wherein the location analysis component further comprises non-transitory instructions operative by the processor to obtain the base location of the consumer from a payment system at which the consumer has previously registered.

20. An apparatus according to claim 18, wherein the location analysis component further comprises non-transitory instructions operative by the processor to obtain the base location of the consumer from a financial institution administering a payment account of the consumer with which the transaction was carried out.

21. An apparatus according to claim 17, wherein the second geographic location is or a geographic location associated with a second past transaction; the second past transaction being chronologically correlated with the first past transaction.

22. An apparatus according to any of claim 16, wherein the location analysis component further comprises non-transitory instructions operative by the processor to identify a plurality of journey segments for each of the consumer, the plurality of journey segments comprising journey segments defined by geographic locations associated with chronologically consecutive transactions performed by the consumer within a pre-defined time span.

23. An apparatus according to any of claim 16, in which the corresponding counts comprise counts associated with the respective journey segments performed by each of the consumers.

24. An apparatus according to any of claim 16, wherein the operation optimization component further comprises non-transitory instructions operative by the processor to select at least one candidate journey segment using the corresponding counts associated with the respective journey segments and determine the capacity index in respect of the at least one candidate journey segment.

25. An apparatus according to claim 24, wherein the operation optimization component further comprises non-transitory instructions operative by the processor to identify a target journey segment using the capacity index of the at least one candidate journey segment, and generate a notification informing the public transport operator of the target journey segment.

26. An apparatus according to any of claim 16, wherein the public transport operator is selected from one of (i) a taxi service provider and (ii) a bus service provider.

27. An apparatus according to any of claim 16, wherein the operation optimization component further comprises non-transitory instructions operative by the processor to distribute the notification to modify the transport operation being undertaken by the public transport operator in response to the notification in real time.

28. An apparatus according to any of claim 16, wherein the operation optimization component further comprises non-transitory instructions operative by the processor to deliver the notification to cause the transport operation undertaken by the public transport operator to be modified in a scheduled future time.

29. An apparatus according to any of claim 16, wherein the operation optimization component further comprises non-transitory instructions operative by the processor to modify at least one selected from (i) a route serviced by the public transport operator, and (ii) a schedule undertaken by the public transport operator.

30. An apparatus according to any of claim 16, wherein the corresponding counts associated with the respective journey segments are the corresponding frequencies associated with the respective journey segments.

31. A non-transitory computer-readable medium, the computer-readable medium having stored thereon program instructions for causing at least one processor to perform operations of:
(a) obtaining transaction data representing past transactions performed by a plurality of consumers via a payment network, said transaction data comprising geographic data indicative of geographic locations at which the respective transactions were carried out;
(b) for each of the consumers, identifying at least one a journey segment performed by the consumer using a first geographic location associated with a first one of the past transactions, and a second geographic location;
(c) storing, in a database, the identified journey segments and corresponding counts associated with the respective journey segments;
(d) determining a capacity index representing a capability of an existing public transport system to accommodate at least one of the identified journey segments using the database; and
(e) generating a notification to modify a transport operation undertaken by a public transport operator based on the capacity index.
